(19) United States
(12) Patent Application Publication
(10) Pub. No.: US 2025/0103283 A1
(43) Pub. Date: Mar. 27, 2025

(54) EFFICIENTLY BUILDING EXPONENTIAL HISTOGRAMS

(71) Applicant: VMware LLC, Palo Alto, CA (US)

(72) Inventors: Lyubomir Plamenov Koev, Sofia (BG); Seraphime Dimitrov Kirkovski, Plovdiv (BG); Andrey Hristov Rachev, Sofia (BG); Petko Naydenov Padevski, Troyan (BG); Julieta Dancheva Ignatova, Sofia (BG)

(21) Appl. No.: 18/475,099

(22) Filed: Sep. 26, 2023

(51) Int. Cl. G06F 5/01

(52) U.S. Cl. CPC G06F 5/01

(57) ABSTRACT

Computer-implemented techniques for efficiently building exponential histograms are provided. In certain embodiments, these techniques can insert a sample into an exponential histogram with n bins in constant (i.e., O(1)) time, rather than O(n) time. Accordingly, these techniques can scale well for large values of n (which allows for a high level of histogram detail/granularity) and can avoid sample skew when building an exponential histogram of software process runtimes or other software metrics.

### BACKGROUND

Unless otherwise indicated, the subject matter described in this section should not be construed as prior art to the claims of the present application and is not admitted as being prior art by inclusion in this section.

A histogram is a graph that displays the distribution of a set of values, referred to as samples, over a continuous numerical range. Building the histogram generally involves dividing the range into a sequence of intervals, known as bins; “inserting” each sample by finding the bin that it falls into and incrementing a bin count (i.e., data frequency) for that bin; and upon inserting all samples, plotting the bins as rectangles in ascending bin order such that the height of each rectangle indicates the bin count of the rectangle's bin.

A linear histogram is a histogram with equal-sized bins. In contrast, an exponential histogram is a histogram where each successive bin is exponentially larger in size. Exponential histograms are useful for several use cases/applications, such as visualizing the distribution of runtimes (i.e., execution durations) of software processes. However, existing techniques for building exponential histograms are inefficient, largely because the time needed to insert each sample is proportional to the number of bins. This is particularly problematic when building an exponential histogram of the runtimes of a software process concurrently with running the process itself, as the time required for sample insertion can potentially skew the sample data.

### BRIEF DESCRIPTION OF THE DRAWINGS

FIG. 1 depicts an example computer system.

FIG. 2 depicts a workflow for efficiently inserting a sample into an exponential histogram using a first approach according to certain embodiments.

FIG. 3 depicts a workflow for efficiently inserting a sample into an exponential histogram using a second approach according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to computer-implemented techniques for building exponential histograms in an efficient manner. At a high level, these techniques can insert a sample into an exponential histogram with n bins in constant (i.e., O(1)) time, rather than O(n) time. Accordingly, these techniques can scale well for large values of n (which allows for a high level of histogram detail/granularity) and can avoid sample skew when building an exponential histogram of software process runtimes or other software metrics.

### 1. Example Computer System and Solution Overview

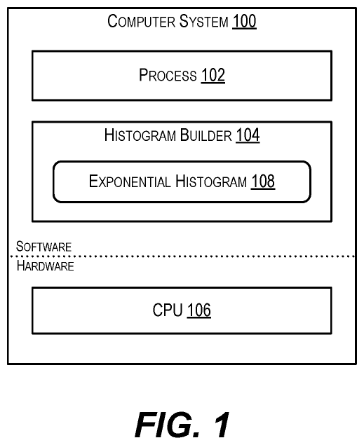

FIG. 1 is a simplified block diagram of an example computer system 100 that may implement the techniques of the present disclosure. As shown, computer system 100 includes in software a process 102 and a histogram builder (hereinafter simply “builder”) 104. Process 102 may be, e.g., a user-level application or service, a kernel function, or any other type of software process known in the art. Computer system 100 further includes in hardware a physical central processing unit (CPU) 106.

Each time process 102 is executed by CPU 106, builder 104 (which also runs on CPU 106) is configured to measure the process' runtime (or in other words, the total duration of its execution) and insert the runtime as a sample into a histogram 108 for process 102. This insertion process involves identifying the histogram bin that the runtime falls into (by, e.g., bin index) and incrementing the identified bin's associated bin count. Once a sufficient number of runtimes are inserted, builder 104 (or some entity) can render histogram 108 by plotting the bins as a series of rectangles, each having a height indicative of its bin count, and the rendered histogram can be used to gain insights into process 102. For instance, process 102 may be an application programming interface (API) that is commonly called by other processes and the rendered histogram may help a human reviewer understand the performance of the API (by virtue of its distribution of runtimes) and implement potential optimizations.

For the purposes of this disclosure, it is assumed that histogram 108 built by builder 104 is specifically an exponential histogram, or in other words a histogram with bins that grow in size according to an exponent factor e. By way of example, the following table presents the bins for a simple exponential histogram that uses an exponent factor e=2 and covers a range of integers from 0 to 29.

TABLE 1

| Bin index | Interval |
|---|---|
| 0 | [0, 1] |
| 1 | [2, 5] |
| 2 | [6, 13] |
| 3 | [14, 29] |

As shown, each successive bin of the histogram is twice the size of the previous bin due the exponent factor of 2. This exponential bin sizing is particularly useful for visualizing the runtime distributions of software processes like process 102 because, for a given process, most of its runtimes will be similar to each other (referred to as typical runtimes), while a small number of its runtimes will be significantly slower (referred to as atypical runtimes). For instance, process 102 may usually complete its execution in a few microseconds, but on rare occasions may take several seconds due to CPU contention and/or other factors. Thus, an exponential histogram can more densely cover the typical runtimes (which correspond to most samples) and less densely cover the atypical runtimes (which correspond to a few samples) and thereby convey detailed distribution information regarding the majority of the samples in the histogram, which is desirable.

As noted in the Background section, one issue with building an exponential histogram using existing techniques is that the operation of inserting a sample into the histogram takes O(n) time, where n is number of bins. This is problematic for at least two reasons. First, it is generally preferable for n to be large (as this directly impacts the level of detail provided by the histogram), which means that the insert operation will be slow. Second, in a scenario where the exponential histogram pertains to process runtimes as in FIG. 1, it is possible for the insertion operation to skew the runtime samples of the process being measured and/or limit the volume of samples than can be collected in real-time. This in turn can lead to an inaccurate or ineffectual histogram.

To address the foregoing, embodiments of the present disclosure provide two novel approaches that may be implemented by builder 104 of FIG. 1 for efficiently inserting samples into exponential histogram 108. Generally speaking, with either of these approaches, builder 104 can insert each sample in constant time (i.e., O(1)) rather than O(n) time and thus overcome the problems described above.

The first approach (referred to as the “general approach”) can be applied to exponential histograms that use any exponent factor e and provides a moderate speedup over existing O(n) insertion techniques. The second approach (referred to as the “CPU-optimized approach”) can only be applied to exponential histograms that use an exponent factor e=2 (such that each successive bin doubles in size) but leverages certain hardware instructions implemented by CPU 106 to provide a larger speedup. Each of these approaches is explained in turn below.

It should be appreciated that FIG. 1 and the foregoing description are illustrative and not intended to limit embodiments of the present disclosure. For example, while FIG. 1 focuses on a scenario in which the exponential histogram being built (i.e., 108) is specifically a histogram of software process runtimes, the approaches described herein are not limited to this use case and may be used to efficiently build exponential histograms comprising any type of sample data. Further, although FIG. 1 depict a particular arrangement of components in computer system 100, other arrangements are possible (e.g., the functionality attributed to a particular component may be split into multiple components, components may be combined, etc.). One of ordinary skill in the art will recognize other variations, modifications, and alternatives.

### 2. General Approach

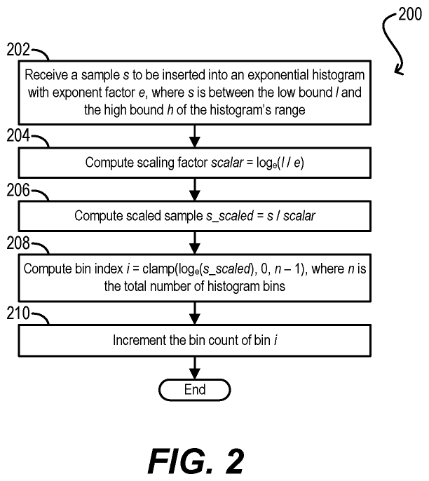

FIG. 2 depicts a workflow 200 that may be performed by computer system 100 of FIG. 1 (via its builder 104) for inserting a sample into exponential histogram 108 using the general approach of the present disclosure according to certain embodiments. As mentioned previously, this general approach works for any exponent factor e.

Starting with step 202, computer system 100 can receive a sample s to be inserted into exponential histogram 108, where s is a numeric value between the low bound (denoted as l) and the high bound (denoted as h) of the histogram's range. For example, in the context of process runtimes, the low bound l may be 16 milliseconds, the high bound h may be 2000 milliseconds, and the value of samples may be 75 milliseconds.

At step 204, computer system 100 can determine a scaling factor scalar to be applied to sample s by dividing low bound l by exponent factor e and calculating the logarithm base e of that result. Stated another way, scalar=logₑ(l/e). Note that this scaling factor can be precomputed a single time for exponential histogram 108 and reused for each sample to be inserted.

At step 206, computer system 100 can compute a scaled version of sample s (denoted as s_scaled) by dividing s by scalar. This step essentially scales the sample to a value between 0 and 1.

Computer system 100 can then compute the index i of the bin that sample s falls into using the formula below (step 208):

$$i = clamp ( {log}_{e} ( s\_scaled ) , 0 , n - 1 ) \qquad Listing 1$$

In this formula, n is the total number of bins in exponential histogram 108.

Finally, at step 210, computer system 100 can increment the bin count of bin i (thereby completing the insertion of sample s) and the workflow can end.

### 3. CPU-Optimized Approach

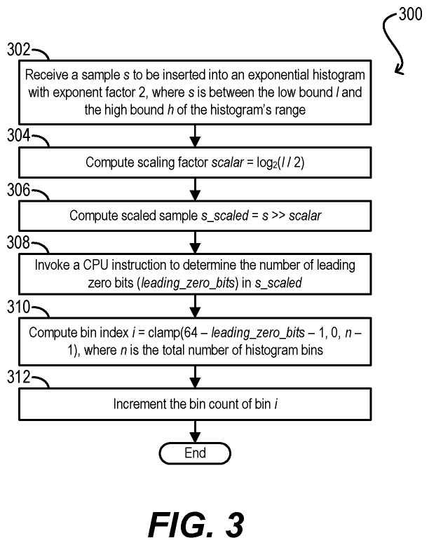

FIG. 3 depicts a workflow 300 that may be performed by computer system 100 of FIG. 1 (via its builder 104) for inserting a sample into exponential histogram 108 using the CPU-optimized approach of the present disclosure according to certain embodiments. This CPU-optimized approach is limited to exponential histograms that use an exponent factor of 2 but is faster than the general approach for two reasons: (1) it replaces the division operation used to compute scaled sample s_scaled with a simple right bit-shift operation, and (2) it replaces the log base e operation used in the formula for bin index i with a faster series of operations that includes leveraging a CPU instruction to compute the number of leading zero bits in s_scaled.

Starting with step 302, computer system 100 can receive a sample s to be inserted into exponential histogram 108, where s is a numeric value between the low bound (denoted as l) and the high bound (denoted as h) of the histogram's range.

At step 304, computer system 100 can determine a scaling factor scalar to be applied to sample s by dividing low bound l by exponent factor 2 and calculating the logarithm base 2 of that result (i.e., log₂(l/2)). As with the general approach, this scale factor can be precomputed a single time for exponential histogram 108 and reused for each sample to be inserted.

At step 306, computer system 100 can compute a scaled version of sample s (i.e., s_scaled) by performing a right bit-shift of s by scalar. Stated another way, s_scaled=s>>scalar. As mentioned previously, this right bit-shift operation replaces the division operation performed at step 206 of FIG. 2, which is possible because performing a right-bit shift of s by scalar is functionally equivalent to performing a division of s by scalar in the case where e=2.

At step 308, computer system 100 can invoke a CPU instruction to determine, via the hardware of its CPU 106, the number of leading zero bits in scaled sample s_scaled (denoted as leading_zero_bits). The following is an example function that may be used to perform this step using the compiler intrinsic “_builtin_clzll” for the GCC compiler.

int leading_zero_bits=_builtin_clzll(s_scaled) Listing 2

The compiler intrinsic shown above ensures that the correct CPU instruction is invoked for performing the leading-zero-bits determination, given the architecture of CPU 106 (e.g., x86-64, ARM64, etc.). If CPU 106 cannot perform this determination in hardware, the compiler intrinsic can instead cause it to be performed in software.

Upon obtaining leading_zero_bits, at step 310 computer system 100 can compute the index i of the bin that sample s falls into using the following formula:

$$i = clamp ( 64 - leading\_zero \_bits - 1 , 0 , n - 1 ) \qquad Listing 3$$

This formula assumes that scaled_s is a 64-bit value and thus subtracts leading_zero_bits from 64 to find the magnitude of s_scaled, which is functionally equivalent to computing log₂(s_scaled) per the general approach.

Finally, at step 312, computer system 100 can increment the bin count of bin i (thereby completing the insertion of sample s) and the workflow can end.

To further clarify how the CPU-optimized approach works, consider a scenario in which exponential histogram 108 has a low bound l=8, a high bound h=2147483648, and an exponent factor e=2, resulting in the following sequence of bins (note that all samples below the low bound will fall into the first bin and all samples above the high bound fall will into the last bin):

TABLE 2

| Bin index | Interval |
|---|---|
| 0 | [0, 7] |
| 1 | [8, 15] |
| 2 | [16, 31] |
| 3 | [32, 63] |
| 4 | [64, 127] |
| 5 | [128, 255] |
| 6 | [256, 511] |
| 7 | [512, 1023] |
| 8 | [1024, 2047] |
| 9 | [2048, 4095] |
| 10 | [4096, 8191] |
| 11 | [8192, 16383] |
| 12 | [16384, 32767] |
| 13 | [32768, 65535] |
| 14 | [65536, 131071] |
| 15 | [131072, 262143] |
| 16 | [262144, 524287] |
| 17 | [524288, 1048575] |
| 18 | [1048576, 2097151] |
| 19 | [2097152, 4194303] |
| 20 | [4194304, 8388607] |
| 21 | [8388608, 16777215] |
| 22 | [16777216, 33554431] |
| 23 | [33554432, 67108863] |
| 24 | [67108864, 134217727] |
| 25 | [134217728, 268435455] |
| 26 | [268435456, 536870911] |
| 27 | [536870912, 1073741823] |
| 28 | [1073741824, 2147483647] |
| 29 | [2147483648, +inf] |

In this scenario, the scaling factor scalar will be log₂(8/2)=2. Further, the bin indices that will be computed by computer system 100 via the formula at step 310 (for sample values at the very lower and upper ends of the histogram's range) are shown below:

TABLE 3

| Sample value | Computed bin index |
|---|---|
| 0 | 0 |
| 1 | 0 |
| 2 | 0 |
| 3 | 0 |
| 4 | 0 |
| 5 | 0 |
| 6 | 0 |
| 7 | 0 |
| 8 | 1 |
| 9 | 1 |
| . . . | . . . |
| 2147483645 | 28 |
| 2147483646 | 28 |
| 2147483647 | 28 |
| 2147483648 | 29 |
| 2147483649 | 29 |
| 2147483650 | 29 |

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, a sample to be inserted into an exponential histogram, wherein the sample is a value between a low bound and a high bound of a continuous numerical range, and wherein the exponential histogram comprises a plurality of bins that span the continuous numerical range and that grow exponentially in size; and
inserting, by the computer system, the sample into the exponential histogram by:
computing a scaling factor for the sample based on the low bound;
computing a scaled version of the sample based on the scaling factor;
invoking an instruction implemented in hardware by a central processing unit (CPU) of the computer system to determine a number of leading zero bits in the scaled version of the sample;
computing a bin index identifying a bin in the plurality of bins that the sample falls into based on the number of leading zero bits and a total number of the plurality of bins; and
incrementing a bin count of the bin identified by the bin index.

2. The method of claim 1 wherein the inserting of the sample is completed in O(1) time.

3. The method of claim 1 wherein the exponential histogram uses an exponent factor of 2, such that each successive bin in the plurality of bins doubles in size.

4. The method of claim 1 wherein computing the scaling factor comprises:
dividing the low bound by 2 to generate an intermediate result; and
computing a logarithm base 2 of the intermediate result.

5. The method of claim 1 wherein computing the scaled version of the sample comprises:
performing a right bit-shift of the sample by the scaling factor.

6. The method of claim 1 wherein computing the bin index comprises:
subtracting the number of leading bits from 63 to generate an intermediate result; and
applying a clamp function to the intermediate result, wherein a lower bound of the clamp function is 0 and wherein an upper bound of the clamp function is the total number of the plurality of bins minus 1.

7. The method of claim 1 wherein the sample is a runtime of a software process.

8. A non-transitory computer readable storage medium having stored thereon program code executable by a computer system, the program code causing the computer system to execute a method comprising:
receiving a sample to be inserted into an exponential histogram, wherein the sample is a value between a low bound and a high bound of a continuous numerical range, and wherein the exponential histogram comprises a plurality of bins that span the continuous numerical range and that grow exponentially in size; and
inserting the sample into the exponential histogram by:
computing a scaling factor for the sample based on the low bound;
computing a scaled version of the sample based on the scaling factor;
invoking an instruction implemented in hardware by a central processing unit (CPU) of the computer system to determine a number of leading zero bits in the scaled version of the sample;
computing a bin index identifying a bin in the plurality of bins that the sample falls into based on the number of leading zero bits and a total number of the plurality of bins; and
incrementing a bin count of the bin identified by the bin index.

9. The non-transitory computer readable storage medium of claim 8 wherein the inserting of the sample is completed in O(1) time.

10. The non-transitory computer readable storage medium of claim 8 wherein the exponential histogram uses an exponent factor of 2, such that each successive bin in the plurality of bins doubles in size.

11. The non-transitory computer readable storage medium of claim 8 wherein computing the scaling factor comprises:
dividing the low bound by 2 to generate an intermediate result; and
computing a logarithm base 2 of the intermediate result.

12. The non-transitory computer readable storage medium of claim 8 wherein computing the scaled version of the sample comprises:
performing a right bit-shift of the sample by the scaling factor.

13. The non-transitory computer readable storage medium of claim 8 wherein computing the bin index comprises:
subtracting the number of leading zero bits from 63 to generate an intermediate result; and
applying a clamp function to the intermediate result, wherein a lower bound of the clamp function is 0 and wherein an upper bound of the clamp function is the total number of the plurality of bins minus 1.

14. The non-transitory computer readable storage medium of claim 8 wherein the sample is a runtime of a software process.

15. A computer system comprising:
a processor; and
a non-transitory computer readable medium having stored thereon program code that, when executed by the processor, causes the processor to:
receive a sample to be inserted into an exponential histogram, wherein the sample is a value between a low bound and a high bound of a continuous numerical range, and wherein the exponential histogram comprises a plurality of bins that span the continuous numerical range and that grow exponentially in size; and
insert the sample into the exponential histogram by:
computing a scaling factor for the sample based on the low bound;
computing a scaled version of the sample based on the scaling factor;
executing an instruction implemented in hardware by the processor to determine a number of leading zero bits in the scaled version of the sample;
computing a bin index identifying a bin in the plurality of bins that the sample falls into based on the number of leading zero bits and a total number of the plurality of bins; and
incrementing a bin count of the bin identified by the bin index.

16. The computer system of claim 15 wherein the processor completes the inserting of the sample in O(1) time.

17. The computer system of claim 15 wherein the exponential histogram uses an exponent factor of 2, such that each successive bin in the plurality of bins doubles in size.

18. The computer system of claim 15 wherein computing the scaling factor comprises:
dividing the low bound by 2 to generate an intermediate result; and
computing a logarithm base 2 of the intermediate result.

19. The computer system of claim 15 wherein computing the scaled version of the sample comprises:
performing a right bit-shift of the sample by the scaling factor.

20. The computer system of claim 15 wherein computing the bin index comprises:
subtracting the number of leading zero bits from 63 to generate an intermediate result; and
applying a clamp function to the intermediate result, wherein a lower bound of the clamp function is 0 and wherein an upper bound of the clamp function is the total number of the plurality of bins minus 1.

21. The computer system of claim 15 wherein the sample is a runtime of a software process.
